(19) United States
(12) Patent Application Publication
(10) Pub. No.: US 2013/0065997 A1
(43) Pub. Date: Mar. 14, 2013

(54) WATER-, SOLVENT- AND PHTHALATE-FREE, SILANE-MODIFIED ONE-COMPONENT PARQUET ADHESIVE AND USE THEREOF FOR EXTREMELY DIMENSIONALLY-STABLE GLUING OF PARQUET, WOODEN FLOOR COVERINGS AND WOOD-BASED MATERIAL BOARDS IN INTERIOR FITMENT

(71) Applicant: Frank GAHLMANN, Hilchenbach (DE)

(72) Inventor: Frank GAHLMANN, Hilchenbach (DE)

(73) Assignee: STAUF KLEBSTOFFWERK GMBH, Wilnsdorf (DE)

(21) Appl. No.: 13/588,988

(22) Filed: Aug. 17, 2012

Related U.S. Application Data
(63) Continuation-in-part of application No. PCT/EP2011/004197, filed on Aug. 19, 2011.

(30) Foreign Application Priority Data
Aug. 20, 2010 (DE) 102010034997.6

(51) Int. Cl. C09J 171/02

(52) U.S. Cl. CPC C09J 171/02
USPC 524/262

(57) ABSTRACT

The present invention relates to a silane-modified, one-component water-, solvent- and phthalate-free parquet adhesive and also to the use thereof for extremely dimensionally-stable gluing of parquet, wooden floor coverings and wood-based material boards to sub-floors in interior fitment.

This patent application is a continuation-in-part of International Patent Application No. PCT/EP2011/04197, filed Aug. 19, 2011, which claims priority to DE 10 2010 034 997.6-43, filed Aug. 20, 2010, both of which are incorporated herein by reference in their entireties.

The present invention relates to a silane-modified, one-component water-, solvent- and phthalate-free parquet adhesive and also to the use thereof for extremely dimensionally-stable gluing of parquet, wooden floor coverings and wood-based material boards to sub-floors in interior fitment.

Common one- and two-component parquet adhesive systems comprise either solvents, water, health-endangering substances, such as e.g. isocyanates, or they do not achieve the mechanical characteristic values required for extremely dimensionally-stable parquet gluing, in particular with respect to tension shear strength and modulus of elasticity. The parquet adhesive according to the invention overcomes these problems by its special composition, based on at least one silane-terminated, moisture-reactive polyalkylene oxide oligomer with at least three mineral components and also suitable drying agent and adhesion promoter. Advantageously, in addition at least one hardening catalyst, UV light absorber, antioxidant, plasticizer (phthalate-free), liquid-extender and rheological additive are contained. The terminal silane groups of the at least one polyalkylene oxide oligomer are bonded via urethane- and/or urea groups to the oligomeric skeletal structure. Drying agent and adhesion promoter comprise moisture-reactive silane groups, preferably trimethoxysilane groups. The at least three mineral components are present in defined mixing ratios relative to each other and relative to the ready-to-use product and are characterised with respect to type, surface quality and particle size.

The present invention relates to a silane-modified, one-component water-, solvent- and phthalate-free parquet adhesive and also to the use thereof for extremely dimensionally-stable gluing of parquet, wooden floor coverings and wood-based material boards to sub-floors in interior fitment.

It must be taken into account in the gluing of wooden floor elements, in particular parquet, that wood is a “working” material. The wooden floor covering expands upon absorption of moisture and contracts when drying. The wood moisture can change for example by water absorption from the sub-floor during drying of a fresh concrete- or screed sub-floor or due to the air humidity values which vary seasonally. The type and intensity of use of the room has an additional influence, such as e.g. duration and intensity of the room heating, air-conditioning or quantity and frequency of water and/or snow introduced via e.g. clothing or shoes. The ambient temperature which depends essentially upon the seasonal changes and the room heating or air-conditioning has a further influence on the dimension of the wood.

The expansions and shrinkages in the wooden floor covering which occur under these influences lead to shear forces which the parquet adhesive and the gluing must withstand and which the parquet adhesive must reduce by deformation to a defined degree. Otherwise, the danger of bulging, warping, formation of cracks and gaps in the wood or destruction of the sub-floor would exist with the damage resulting therefrom and problems with respect to safety, hygiene and appearance.

In order to minimise these physical constructional problems, a minimal tension shear strength of 3.5 N/mm² (storage type A) is required in the DIN EN Standard 14293:2006-10 which is current for parquet adhesives.

In addition to the tension shear strength, the modulus of elasticity is an important indicator of the dimensional stability of the parquet gluing. With an increasing modulus of elasticity, the elasticity of the hardened adhesive decreases. This results in higher restoring forces of the adhesive matrix and has the effect that the covering wood remains fixed better at the adhesion point and less danger of bulging, warping and formation of cracks and gaps results.

Normally adhesives are used for gluing wooden covering elements, in particular parquet, which can be divided into the following classes: dispersion adhesives, solvent adhesives, powder adhesives, methylenediisocyanate (MDI)-based two-component polyurethane adhesives, MDI-based one-component polyurethane adhesives, toluene diisocyanate (TDI)-based polyurethane adhesives and silane-modified polymeric adhesive (SMP-adhesives).

Dispersion adhesives based on vinyl acetate homopolymer dispersions have been used since the fifties for gluing parquet. They bond by evaporation of the water, the adhesion being based exclusively on physical interactions of the molecules (dipole-dipole-, van der Waals interactions). What is disadvantageous with these parquet adhesives which have been used to date is the high water content which can lead to significant swelling of the wood and consequently to large dimensional changes in the parquet and other wooden floor coverings. Furthermore, the small amount of time which remains for laying the wooden floor covering elements after application of the adhesive on the sub-floor (open time) is disadvantageous. The high glass transition temperature of the vinyl acetate homopolymers makes it necessary in addition to use coalescent agents in order to achieve filming of the dispersion at the processing temperature (room temperature). Coalescent agents are volatile organic compounds (VOCs) which, even after gluing of the parquet, are still discharged in the room air for a fairly long period of time and hence can represent environmental and health risks.

A further development of the dispersion parquet adhesives based on vinyl acetate homopolymer dispersions are the parquet adhesives based on vinyl acetate-ethylene copolymer dispersions. In the case of these similarly formulated adhesives, the lower glass transition temperature of the copolymer dispersions requires no coalescent agents. In addition, also special dispersions based on styrene-acrylic acid ester copolymers are used nowadays. These adhesives can be formulated likewise without coalescent agents because of the low glass transition temperature of the dispersions. However, the wood-swelling properties and the short open times of merely 10 to 20 minutes continue to be disadvantageous.

At the end of the sixties, solvent-synthetic resin parquet adhesives were introduced. These adhesives are based on solutions of vinyl acetate homopolymers in a solvent mixture which can comprise methanol, ethanol, methyl acetate, ethyl acetate and acetone. They bond very rapidly by evaporation of the solvent. What is advantageous with these parquet adhesives used to date are the wood-swelling properties which are reduced by approx. 50 to 70% in comparison with dispersion parquet adhesives. However, the high content of solvents, the emission of which means a burden to the processor and to the environment, is disadvantageous and consequently use in interiors is limited. The products are generally characterised as readily-inflammable and health-damaging or irritant. In addition, the open times of these parquet adhesives are particularly short (5 to 10 minutes) and hence disadvantageous for the processing process.

An advantageous further development of these parquet adhesives, with respect to solvent emissions, is disclosed in a patent of Stauf Klebstoffwerk GmbH (U.S. Pat. No. 7,420,009 B2: LOW EMISSION ADHESIVE COMPOSITION BASED ON A SOLVENT).

Another further development of the dispersion parquet adhesives is pulverulent adhesive formulations. These are based on re-emulsifiable dispersion powders—generally vinyl acetate-ethylene copolymers. They contain a mineral component which can comprise calcium sulphate hemihydrate, Portland cement or aluminate cement. These adhesives concern 2-component systems which consist of powder and a further component. The second component which is mixed with the powder component is water or a polymer dispersion. The advantage of this class of parquet adhesives is the chemical water bonding of the mineral component. The disadvantageous wood swelling of the dispersion adhesives is reduced consequently to approximately the level of solvent-synthetic resin parquet adhesives. The limited pot life between mixing the components and the end of the processing in which the chemical reaction takes place which increasingly effects a viscosity increase is disadvantageous. The laying time (open time) between the application of the adhesive and laying of the wooden floor element is just as short as in the case of dispersion parquet adhesives. In addition, the difficulties which are basically inherent to all two-component systems and reside in the additional mixing complexity, in the danger of non-homogeneous mixing and in inadequate adjustment of the mixing ratio by the user are disadvantageous.

In the nineties, reaction adhesives based on polyurethane for gluing parquet were introduced. At first these were two-component systems which consist of a resin component and an isocyanate hardener. The binding agent in the resin component is a hydroxy-functional polyol; the formulated resin component contains in addition water scavengers, mineral fillers, catalysts and additives. The isocyanate hardener component generally consists of commercial, oligomeric methylene diphenyldiisocyanate (MDI, often also termed polymer MDI). In the case of these adhesives, the wood-swelling effect which is again reduced in comparison with powder parquet adhesives and hence no longer relevant in practice and also the longer open times of approx. 30 to 60 minutes are advantageous. The very high strength of the gluing with moduli of elasticity of the order of magnitude of 40 to 100 N/mm² and tension shear strengths of 5 to 9 N/mm² represent excellent dimensional stability which however must be at the expense of the disadvantage of comparatively high stress to the sub-floor. The shear forces occurring, in particular in the case of sub-floors which are associated with weak points, can lead to breakages and the formation of cracks. Furthermore, the danger to health and environment which is based on the isocyanate content and is expressed inter alia in the hazardous material labelling according to the international GHS system or the German Ordinance on Hazardous Substances is disadvantageous. Accordingly, these adhesives are classed as health-damaging, irritant and sensitising. Furthermore, the problems which are basically inherent to all two-component systems, as were described already in the case of powder adhesives, are disadvantageous.

Shortly after the two-component polyurethane adhesives, reactive one-component polyurethane parquet adhesives were developed. The basis of these adhesives is isocyanate group-containing, moisture-reactive prepolymers or oligomers based on methylene diphenyldiisocyanate (MDI) which often also comprise oligomeric and monomeric MDI. Further components of these adhesives are mineral fillers, catalysts and additives. In comparison with two-component polyurethane adhesives, the again extended open times (45 to 120 minutes) are advantageous, which together with the one-component aspect facilitate handling and processing of the adhesive. The wood-swelling effect corresponds to that of two-component polyurethane adhesives and is correspondingly unproblematic. The mechanical properties are furthermore advantageous. The strengths of the gluing which are achieved cause, on the one hand, high dimensional stability and, on the other hand, sub-floor stress which is less than that of the two-component polyurethane systems. However, what is disadvantageous in one-component polyurethane adhesives is furthermore the danger to health and environment, which corresponds to that of two-component polyurethane parquet adhesives, and is based on a residual content of monomeric and oligomeric MDI in the prepolymers or oligomers.

At the end of the nineties, one-component reaction adhesives based on toluene diisocyanate oligomers (TDI adhesives) for gluing wooden floor coverings were introduced. In comparison with the established MDI-based polyurethane adhesives, the advantage of these adhesives is that they are not classed as health-damaging, irritant or sensitising and they do not require a specific labelling according to the current international GHS labelling system and the German Ordinance on Hazardous Substances. This property can be attributed to their extremely low residual content of monomeric TDI. With respect to the open time and wood-swelling properties, they are similar to the MDI-based polyurethane adhesives. In comparison with these, the significantly higher elasticity and lower strength and dimensional stability of the produced gluing is however disadvantageous. The normal moduli of elasticity in the case of MDI-based polyurethane-, dispersion-, powder- and solvent adhesives are not attained by approx. one order of magnitude. Hence, TDI-based polyurethane adhesives are suitable above all for parquet gluing on unstable sub-floors which tolerate only low stress due to shear and adhesive tensile forces.

The newest development is parquet adhesives based on silane-modified, oligomeric compounds, so-called SMP adhesives (now and then also termed hybrid adhesives). These adhesives are characterised by oligomeric organic compounds (frequently also termed prepolymers) which carry moisture-reactive silane groups, generally dimethoxymethylsilane- or trimethoxysilane groups. After contact with moisture from the sub-floor, the covering wood or the air, the moisture-reactive silane groups crosslink by means of hydrolysis and subsequent condensation to form a three-dimensional siloxane network, the adhesive matrix.

Further components of these adhesives are typically liquid extenders, plasticizers, mineral fillers, water scavengers, adhesion promoters, catalysts and further additives.

For the gluing of parquet, silane-modified adhesives generally have the following advantages:
one-component aspect
free of water and solvents
sufficiently long open times
no relevant wood-swelling effect in practice
not classed as environment- or health-endangering and therefore need no labelling according to the German Ordinance on Hazardous Substances and the international GHS labelling system.

The pseudo-plastic rheology of SMP parquet adhesives is furthermore advantageous. In practice, this means that the adhesives do not flow and can be applied well with a toothed spatula. Drawn tracks of adhesive remain stable in shape and hence offer an important pre-condition of being able to bridge fairly small cavities between wooden floor covering and sub-floor.

What is disadvantageous with the SMP parquet adhesives—similarly to the labelling-free TDI-based polyurethane adhesives—is the high elasticity and low strength of the polymer matrix formed after hardening. The mechanical properties are in fact better than those of the labelling-free TDI-based polyurethane adhesives. Nevertheless, they are inadequate for extremely dimensionally-stable gluing. Typically, the tension shear strengths are in the range of 1.0 to 2.0 N/mm² and the moduli of elasticity in the range 1.0 to 3.0 N/mm². Hence, they are significantly below the values which are achieved by conventional parquet adhesives from the group of polyurethane-, dispersion-, powder- and solvent adhesives. Whilst the last-mentioned typically maintain the requirements of DIN EN 14293 with respect to minimum tension shear strength, this is not the case with SMP parquet adhesives. According to the current state of the art, a tension shear strength of 4.0 N/mm² (test conditions DIN EN 14293:2006-10, storage type A) and a modulus of elasticity of 7.5 N/mm² (test conditions DIN EN ISO 527-1: 1996-04 and DIN EN ISO 527-3: 2003-07) is not achieved by any silane-modified parquet adhesive—a circumstance which has to date militated against greater acceptance and use of these parquet adhesives.

Starting from this state of the art, it is the object of the present invention to make available a parquet adhesive which has all or several of the following advantages: it should be easy to apply, ensure a sufficiently long open time, have no relevant wood-swelling effect, not endanger health and environment, be free of water, solvents and phthalates, have good adhesion properties on sub-floors which are common in interior fitment, produce high strength in the gluing and ensure high dimensional stability of the glued wooden covering. Advantageously, the available parquet adhesive should produce a tension shear strength of at least 4.0 N/mm² (test conditions DIN EN 14293:2006-10, storage type A) and a modulus of elasticity of at least 7.5 N/mm² (test conditions DIN EN ISO 527-1:1996-04 and DIN EN ISO 527-3:2003-07). A further object of the invention is to make available the use of the parquet adhesive according to the invention for gluing parquet, wooden floor coverings and wood-based material boards to sub-floors which are common in interior fitment with the objectives indicated for the parquet adhesive.

This object is achieved by the features of the one-component, silane-modified, water-, solvent- and phthalate-free parquet adhesive described herein. Advantageous developments of the parquet adhesive according to the invention and of the use according to the invention are also described.

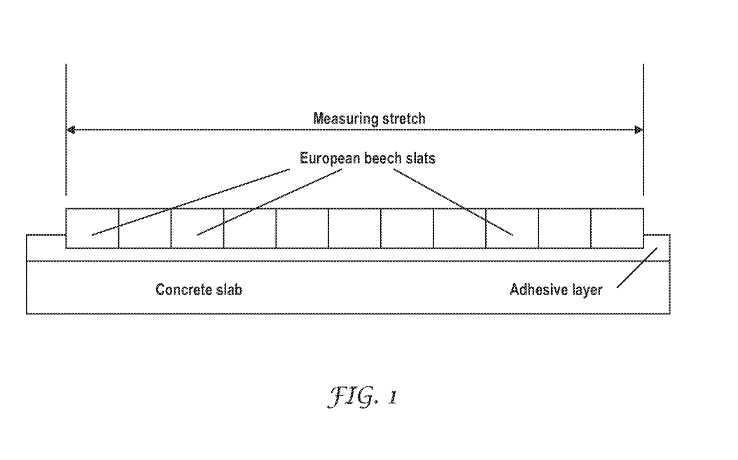

FIG. 1 illustrates test construction for determining dimensional stability of glued parquet in accordance with embodiments of the present invention.

The parquet adhesive according to the invention is a silane-modified parquet adhesive with significantly improved mechanical properties. It has the technical processing and application advantages of the SMP parquet adhesives corresponding to the state of the art without having the disadvantageously low strengths thereof and the dimensional stability problems associated therewith. The advantageous mechanical properties of the parquet adhesive according to the invention, in particular with respect to tension shear strength and modulus of elasticity, can essentially be attributed to the selection of a suitable basic polymer in combination with a specially composed composition of at least three mineral components of a defined type, surface quality and particle size. In addition, also the selection of a suitable drying agent and adhesion promoter are responsible for the advantageous adhesive properties.

Molecular weight data of all oligomers and polymers specified within the framework of this invention (especially those of silane-terminated polyalkylene oxide binding agents of adhesive compositions according to the invention and reference adhesive compositions) are average number molecular weights (Mn), as it is standard in this technical field.

According to the invention, the one-component, silane-modified, water-, solvent- and phthalate-free parquet adhesive which is suitable for extremely dimensionally-stable gluing of parquet, wooden floor coverings and wood-based material boards to sub-floors which are common in interior fitment comprises the following materials or consists of them:
a) 10 to 30 percent by mass of a moisture-reactive, silane-terminated polyalkylene oxide binding agent with an average molecular weight of 6,000 to 20,000 g/mol,
   the silane functions being bonded via urethane- and/or urea groups to the oligomeric skeletal structure,
b) 30 to 60 percent by mass of a surface-hydrophobised chalk powder with an average particle diameter of 0.8 to 4.0 μm,
c) 2 to 10 percent by mass of a surface-hydrophobised chalk powder with an average particle diameter of 0.2 to 0.7 μm,
d) 3 to 15 percent by mass of a surface-hydrophobised wollastonite with an average needle length of 15 to 60 μm and an average aspect ratio of 3:1 to 12:1,
e) 0.2 to 3 percent by mass of a moisture-reactive, silane-modified drying agent,
f) 0.3 to 4 percent by mass of a moisture-reactive, silane-modified adhesion promoter,
   the percentage data relating to the mass of the ready-to-use parquet adhesive and the sum of the components a) to f) being 45.5% to 100%.

In particular, the parquet adhesive can have the following proportions of components:
a) 16 to 26 percent by mass of a moisture-reactive, silane-terminated polyalkylene oxide binding agent with an average molecular weight of 7,000 to 13,000 g/mol,
   the terminal silane functions being bonded via urethane- and/or urea groups to the oligomeric skeletal structure,
b) 44 to 54 percent by mass of a surface-hydrophobised chalk powder with an average particle diameter of 0.8 to 1.8 μm,
c) 3 to 6 percent by mass of a surface-hydrophobised chalk powder with an average particle diameter of 0.3 to 0.6 μm,
d) 5 to 10 percent by mass of a surface-hydrophobised wollastonite with an average needle length of 25 to 45 tm and an average aspect ratio of 5:1 to 10:1,
e) 0.5 to 1.5 percent by mass of a moisture-reactive, silane-modified drying agent,
f) 1 to 3 percent by mass of a moisture-reactive, silane-modified adhesion promoter,

the percentage data relating to the mass of the ready-to-use parquet adhesive and the sum of the components a) to f) being 69.5% to 100%.

According to a preferred embodiment, the mass ratio of component b) to component c) is 6:1 to 16:1 and the mass ratio of component c) to component d) is 1:1 to 1:2. In particular, it is advantageous if the mass ratio of component b) to component c) is 9:1 to 15:1 and the mass ratio of component c) to component d) is 1:1.5 to 1:2.

As basic polymer and binding agent, the parquet adhesive according to the invention comprises 10 to 30 percent by mass, preferably 16 to 26 percent by mass, very particularly preferred 21.5 percent by mass of a moisture-reactive, silane-terminated polyalkylene oxide, the silane functions of which are bonded via urethane- and/or urea groups to the oligomeric skeletal structure. Preferably, the oligomeric skeletal structure is a polypropylene oxide and the silane functions are trimethoxysilane groups. The average molecular weight of the oligomer is between 6,000 and 20,000 g/mol, preferably between 7,000 and 13,000 g/mol, very particular preferred at 10,000 g/mol.

At least two mineral components are chalk powder with an average particle size of respectively 0.8 to 4.0 μm, preferably 0.8 to 1.8 μm, very particularly preferred 1.0 μm and of 0.2 to 0.7 μm, preferably 0.3 to 0.6 μm, very particularly preferred 0.4 μm.

The chalk powder with the larger particle size is contained up to 30 to 60 percent by mass, preferably 44 to 54 percent by mass, very particularly preferred 49.1 percent by mass in the parquet adhesive according to the invention, whilst that with the smaller particle size is contained up to 2 to 10 percent by mass, preferably 3 to 6 percent by mass, very particularly preferred 4 percent by mass.

Substitution of the chalks by precipitated calcium carbonate powders is not possible since these have smaller particle sizes than those required according to the invention. Likewise, the substitution of the chalks by other calcium carbonate stone, such as limestone, does not lead to the advantages according to the invention. The surfaces of the chalk particles are hydrophobised.

At least one further mineral component is the fibrously-structured silicate wollastonite which is contained with 3 to 15 percent by mass, preferably 5 to 10 percent by mass, very particularly preferred 7 percent by mass and has an average needle length of 15 to 60 μm, preferably 25 to 45 μm, very particularly preferred 39 μm and an average aspect ratio of 3:1 to 12:1, preferably 5:1 to 10:1, very particularly preferred 7:1. The surfaces of the wollastonite are hydrophobised.

The hydrophobising of the chalk- and silicate particles is effected either by treatment with one or more fatty acids and/or its salt/their salts, preferably by treatment with stearic acid and/or stearate or via silanisation, preferably by conversion with a reactive silane, very particularly preferred by conversion with aminosilane.

As water scavenger, the parquet adhesive according to the invention comprises 0.2 to 3 percent by mass, preferably 0.5 to 1.5 percent by mass, very particularly preferred 0.8 percent by mass of a moisture-reactive, silane-modified drying agent. Trimethoxysilane-terminated alkenes are preferably used, vinyl trimethoxysilane is very particularly preferred.

In order to improve the adhesion properties, the parquet adhesive according to the invention comprises 0.3 to 4 percent by mass, preferably 1 to 3 percent by mass, very particularly preferred 1.9 percent by mass of a moisture-reactive, silane-modified adhesion promoter. Trimethoxysilane-terminated aminoalkyl compounds are preferably used, 3-aminopropyltrimethoxysilane is very particularly preferred.

In order to accelerate the hardening process, the parquet adhesive according to the invention can comprise up to 0.1 percent by mass, preferably 0.005 to 0.05 percent by mass, very particularly preferred 0.025 percent by mass of a hardening catalyst. Organo-transition metal compounds are preferred hardening catalysts, dibutyltin diacetylacetonate is very particularly preferred.

In order to improve storage life, the parquet adhesive according to the invention can comprise advantageously in addition antioxidants and/or UV light absorbers (photostabilisers) of together up to 3 percent by mass, preferably 0.1 to 1 percent by mass, very particularly preferred 0.2 percent by mass.

As antioxidant, preferably sterically hindered phenols are used, preferably 3,5-bis(1,1-dimethylethyl)-4-hydroxybenzylpropanoic acid-C7-C9-isoalkylester.

As UV light absorber, preferably sterically hindered amines are used, preferably bis(1,2,2,6,6-pentamethyl-4-piperidyl)sebacate or methyl-1,2,2,6,6-pentamethyl-4-piperidylsebacate; a mixture of these sebacates is very particularly preferred.

In order to adjust a processing-friendly viscosity, the parquet adhesive according to the invention can comprise advantageously plasticizers and/or liquid-extenders of together up to 20 percent by mass, preferably 7 to 15 percent by mass, very particularly preferred 10.8 percent by mass.

As plasticizer, aromatic alkylsulphonic acid esters, aliphatic cyclic carboxylic acid esters or aliphatic cyclic dicarboxylic acid esters, preferably 1,2-cyclohexanedicarboxylic acid diisononyl ester, can be used.

As liquid-extender, polyether polyols, preferably polypropylene oxide with a molecular weight of 300 to 3,000 g/mol, preferably with 700 to 1,300 g/mol, very particularly preferred with 1,000 g/mol, can be used.

The use of phthalates which are otherwise frequently used is dispensed with completely because of their suspected reproduction-endangering effect. The composition according to the invention of the parquet adhesive has the effect that this does not have a disadvantageous effect, rather the advantageous properties of silane-modified parquet adhesives are retained. In addition, the mechanical properties are significantly improved and high dimensional stability of the parquet gluing is ensured.

As additional binding agent and reactive diluent, the parquet adhesive according to the invention can comprise up to 10 percent by mass, preferably 2 to 6 percent by mass, very particularly preferred 4 percent by mass of a moisture-reactive, silane-terminated polyalkylene oxide, the silane functions of which are bonded via alkyl groups to the oligomeric skeletal structure. Preferably, the oligomeric skeletal structure is a polypropylene oxide and the silane functions are dimethoxymethylsilane groups. The average molecular weight of the oligomer is between 300 and 3,000 g/mol, preferably between 700 and 1,300 g/mol, very particularly preferred at 1,000 g/mol.

As rheological additive, the parquet adhesive according to the invention can comprise in addition up to 3 percent by mass, preferably 0.3 to 1.3 percent by mass, very particular preferred 0.675 percent by mass of a wax, preferably a polyamide wax.

The individual components of the adhesive composition according to the invention can be contained respectively as pure materials or, provided that the criteria applying to the respective component, such as total proportion, mass ratio, molecular weight, structure, chemistry, particle size, needle length, aspect ratio and/or surface quality remain fulfilled, as a mixture of similar materials.

In order to improve or adjust appearance, rheology and/or stability, the parquet adhesive according to the invention can comprise further additives, such as pigments, colourants, organic/inorganic fillers, resins, waxes or preservatives.

The parquet adhesive according to the invention has a series of technical processing and application advantages which no other parquet adhesive combines together in this combination:
one-component aspect
free of water, solvents and phthalates
sufficiently long open time
no relevant wood-swelling effect in practice
not classed as environment- or health-endangering and labelling-free according to the current GHS labelling system and the German Ordinance on Hazardous Substances
high strength of the gluing, observable in particular in tension shear strength
high dimensional stability of the glued covering wood, observable in particular in the modulus of elasticity
pronounced pseudo-plastic rheology with suitable processing viscosity
easy applicability by means of toothed spatula and structure-retaining adhesive tracks
good adhesion properties on moist and dry sub-floors which are common in interior fitment
easy and reliable handling and processing

The parquet adhesive according to the invention is one-component and free of water, solvents and phthalates.

The open time is in the range of 50 to 70 minutes (DIN EN 14293:2006-10), as a result of which a comparatively long processing time is ensured.

Because of the absence therefrom of water and solvents, no relevant wood-swelling effect of the adhesive is present in practice.

The absence of solvents and completely dispensing with the addition of phthalates, isocyanates and other potentially health-endangering substances causes the health- and environment-compatibility of the parquet adhesive according to the invention. This can be observed in the fact that the adhesive does not require to be labelled according to the current German Ordinance on Hazardous Substances and the international GHS hazardous material labelling system.

The parquet adhesive according to the invention has a tension shear strength of ≧4.0 N/mm² (DIN EN 14293:2006-10, storage type A) and a modulus of elasticity of ≧7.5 N/mm² (DIN EN ISO 527-1:1996-04 and DIN EN ISO 527-3:2003-07). Strength values of this order of magnitude have to date not been achieved with silane-modified parquet adhesives. Even with mechanical and/or climatic stress, they ensure high dimensional stability of the glued wooden floor covering. The sub-floor is furthermore not stressed so greatly mechanically as is the case with two-component polyurethane adhesives.

The pronounced pseudo-plastic rheology and viscosity between 80,000 and 140,000 mPa·s (test conditions according to DIN EN ISO 2555:2000-01, 20 revolutions per minute) ensure, together with the one-component aspect, simple handling and processing of the adhesive according to the invention. The adhesive can be applied easily with a toothed spatula and allows adhesive tracks, which are stable in shape, up to a height of 10 mm and more.

The parquet adhesive according to the invention has excellent adhesion properties on all sub-floors which are common in interior fitment, such as concrete, cement, cement screed, cement liquid screed, cement mortar, cement-bonded wood fibre, ceramic, natural stone, calcium sulphate screed, calcium sulphate liquid screed, magnesite screed, wood, wood-based material, plywood, cork, gypsum, gypsum fibre, gypsum plasterboard, hardboard, mineral knifing filler, textile fibrous material or a combination of these sub-floors. The adhesion is also not impaired on sub-floors comprising up to 8 percent by mass of water, such as e.g. moist concrete or cement screed.

Commercially available parquet, wooden floor coverings and/or wood-based material boards which consist entirely or partially of European deciduous and/or coniferous types of timber, non-European types of timber or a combination of these types of timber are glued reliably and in an extremely dimensionally-stable manner to the sub-floor.

The advantageous properties of the parquet adhesive according to the invention ensure likewise simple and reliable handling and processing of the adhesive.

In Table 1, an embodiment of the parquet adhesive according to the invention having a particularly preferred composition is given.

In Table 5 and 6, the compositions of the commercially available parquet adhesives SMP-920 and SMP-930 (Stauf Klebstoffwerk GmbH) are summarised. In subsequent tests, they serve as reference for the adhesive according to the invention.

In the composition thereof, the two commercially available parquet adhesives differ from the parquet adhesive according to the invention essentially by a different composition of basic polymer and mineral components and also the proportion thereof of phthalate. For example the surface-hydrophobised fibrously-structured wollastonite—indispensable mineral component of the adhesive according to the invention—is not contained in the commercially available adhesives. Conversely, both commercially available adhesives comprise limestone powder and partially also precipitated calcium carbonates and silicic acid which do not occur in the parquet adhesive according to the invention. Also the average particle diameters and the distribution profiles thereof differ between adhesive according to the invention and the commercially available formulations. Thus, for example particle sizes of pulverulent mineral components of >4 μm are not contained in the parquet adhesive according to the invention. A further difference resides in the phthalate content which, in the case of SMP-930, is 11 percent by mass (bis(2-propylheptylphthalate) and, in the case of SMP-920, is 20 percent by mass (diisononylphthalate) of the ready-to-use adhesive mixture. In contrast, no phthalate is contained in the parquet adhesive according to the invention. Against the background of a reproduction-damaging effect of the phthalates, SMP-930 should be regarded as of higher quality in comparison with SMP-920.

The tension shear strength of the parquet adhesive according to the invention (composition according to Table 1) was determined according to DIN EN 14293:2006-10 (storage type A) and compared with the commercially available, silane-modified parquet adhesives (SMP-920 and SMP-930, Stauf Klebstoffwerk GmbH).

In comparison with the commercially available, silane-modified parquet adhesives SMP-920 and SMP-930 (Stauf Klebstoffwerk GmbH), the tension shear strengths summarised in Table 2 resulted.

The results show that the parquet adhesive according to the invention, in comparison with SMP-930, has a higher tension shear strength by 124% and, in comparison with SMP-920, even a tension shear strength higher by 146%. The minimum tension shear strength required according to DIN EN 14293:2006-10 of 3.5 N/mm² and also the tension shear strength of at least 4.0 N/mm² claimed according to the invention (storage type A) is achieved or significantly exceeded.

The modulus of elasticity of the parquet adhesive according to the invention (composition according to Table 1) was determined according to DIN EN ISO 527-1:1996-04 and DIN EN ISO 527-3:2003-7. In comparison with the commercially available, silane-modified parquet adhesives SMP-920 and SMP-930, the moduli of elasticity summarised in Table 3 thereby resulted.

The results show that the parquet adhesive according to the invention, in comparison with SMP-930, has a modulus of elasticity which is higher by 367% and, in comparison with SMP-920, even a modulus of elasticity which is higher by 462%. The modulus of elasticity of at least 7.5 N/mm² which is claimed according to the invention is not only achieved but significantly exceeded.

With the parquet adhesive according to the invention described in Table 1, the dimensional stability of the glued parquet was determined (test construction according to FIG. 1) and compared with the commercially available, silane-modified parquet adhesives (SMP-920 and SMP-930, Stauf Klebstoffwerk GmbH) with phthalate proportions of 20 (SMP-920) and 11 percent by mass (SMP-930).

For this purpose, 120 cm×50 cm×5 cm large concrete slabs (strength class C 20/25 according to DIN EN 206-1:2001-07) were stored up to the weight constant in a standard atmosphere of 23° C. and 50% relative air humidity. On the concrete slabs, the adhesive to be tested was applied uniformly in a defined layer thickness of 0.85 mm. Immediately after application of the adhesive, twenty rectangularly cut and planed European beech slats of the dimensions 25 cm×5 cm×1 cm, pre-stored under standard atmosphere, were laid in the centre longitudinal side by longitudinal side without a gap and pressed-on lightly. Only European beech slats with half grain incision were used, i.e. the orientation of the annual rings on the head side which is 1 cm×5 cm large was 45° . The gluing was then left to harden in a climatic chamber for 28 days in a standard atmosphere (23° C./50° relative air humidity) and stored. Now the starting length of the measuring stretch perpendicular to the width of the adjacently situated slats was measured (starting length L_{A}, with 20 slats of approx. 1 m). Subsequently the atmosphere was changed to 10° C. and 85% relative air humidity. Under these atmosphere conditions, the wood moisture rises, the European beech slats attempt to expand and, as a result of the increase in width of the slats, the measuring stretch is lengthened. The dimension of this horizontal expansion is dependent upon the mechanical properties of the adhesive. After 20 days, the length value of the measuring stretch (L_{B}) was read off again. The results are summarised in Table 4.

It is evident from these results that the parquet adhesive according to the invention, in contrast to the commercially available, silane-modified parquet adhesives SMP-920 and SMP-930, allows significantly less wood expansion. In comparison with SMP-930, the horizontal wood expansion is reduced by 55.6% and, in comparison with the somewhat more elastic SMP-920, by 60.1%. This immediately confirms the high dimensional stability, claimed according to the invention, of the wood covering glued with the parquet adhesive according to the invention.

The open time of the adhesive according to the invention (composition according to Table 1) was determined according to DIN EN 14293:2006-10. It was 60 minutes, i.e. within this time period after application of the adhesive, wooden floor coverings can still be pressed into the adhesive layer and glued to the sub-floor. Also lifting of already laid coverings and new alignment thereof can be readily implemented within this time period.

The viscosity according to DIN EN ISO 2555:2000-01 (20 rpm) was determined with the parquet adhesive according to the invention which is described in Table 1. At 20 revolutions per minute, a viscosity of 109,700±6,800 mPa·s was measured (n=5). The viscosity is hence in the range of 80,000 to 140,000 mPa·s, which ensures easy spreadability and adhesive tracks, which are stable in shape, up to a height of more than 10 mm. In combination with the one-component aspect and the open time, this means easy handling and processing of the parquet adhesive according to the invention.

TABLE 1
By way of example, particularly preferred composition of the parquet
adhesive according to the invention (proportions in percent by mass).

| | | | | Proportion |
|---|---|---|---|---|
| Raw material | Chemistry | Function | Manufacturer | [%] |
| Geniosil | Trimethoxysilane-terminated polyurethane | Binding agent, | Wacker Chemie | 21.5 |
| STP-E 15 | oligomer, MW: approx. 10,000 g/mol | basic polymer | | |
| Omyalite | Chalk powder, surface-hydrophobised with | Mineral component | Omya | 49.1 |
| 95 T | stearic acid, average particle diameter: 1.0 μm | | | |
| Omyabond | Chalk powder, surface-hydrophobised with | Mineral component | Omya | 4 |
| 302 | stearic acid, average particle diameter: 0.4 μm | | | |
| Tremin 939 | Wollastonite, surface-silanised, average needle | Mineral component | Quarz-werke | 7 |
| 100 AST | length 39 μm, average aspect ratio 7:1 | | | |
| Geniosil | Vinyltrimethoxysilane | Drying agent | Wacker Chemie | 0.8 |
| XL 10 | | | | |
| Geniosil | 3-aminopropyltrimethoxysilane | Adhesion promoter | Wacker Chemie | 1.9 |
| GF 96 | | | | |
| Metatin | Dibutyltin diacetylacetonate | Catalyst | Acima | 0.025 |
| K 740 | | | | |
| Tinuvin 765 | Mixture of bis(1,2,2,6,6-pentamethyl-4- | UV light absorber | Ciba | 0.05 |
| | piperidyl)sebacate and methyl-1,2,2,6,6- | | | |
| | pentamethyl-4-piperidylsebacate | | | |
| Irganox 1135 | 3,5-bis(1,1-dimethylethyl)-4-hydroxy- | Antioxidant | Ciba | 0.15 |
| | benzylpropanoic acid-C7-C9-isoalkylester | | | |
| Hexamoll | 1,2-cyclohexane dicarboxylic acid | Plasticizer | BASF | 5 |
| DINCH | diisononylester | | | |
| Desmophen | Polypropylene oxide, MW: approx. 1,000 | Liquid-extender | Bayer Material | 5.8 |
| 1110 BD | g/mol | | Science | |
| SAT 010 | Dimethoxymethylsilane-terminated | Binding agent, | Kaneka | 4 |
| | polypropylene oxide oligomer, MW: approx. | reactive diluent | | |
| | 1,000 g/mol | | | |
| Disparlon | Polyamide wax | Rheological | Kusumoto | 0.675 |
| 6100 | | additive | | |

TABLE 2
Results of the tension shear strength test according to DIN EN
14293:2006-10 (storage type A) on parquet adhesive according to
the invention, SMP-930 and SMP-920. Measuring values ± standard
deviation (SD) and also number of respective measurements (n).

| Adhesive | Tension shear strength ± SD |
|---|---|
| Adhesive according to the invention | 4.31 ± 0.27 N/mm² (n = 8) |
| (composition acc. to Table 1) | |
| SMP-930 | 1.92 ± 0.17 N/mm² (n = 7) |
| SMP-920 | 1.75 ± 0.20 N/mm² (n = 6) |

TABLE 3
Results of the modulus of elasticity test according to
DIN EN ISO 527-1:1996-04 and DIN EN ISO 527-3:2003-07
on parquet adhesive according to the invention, SMP-930
and SMP-920. Measuring values ± standard deviation
(SD) and also number of respective measurements (n).

| Adhesive | Modulus of elasticity ± SD |
|---|---|
| Adhesive according to the invention | 8.54 ± 0.46 N/mm² (n = 8) |
| (composition acc. to Table 1) | |
| SMP-930 | 1.83 ± 0.26 N/mm² (n = 7) |
| SMP-920 | 1.52 ± 0.18 N/mm² (n = 7) |

TABLE 4
Results relating to the dimensional stability measurement of parquet adhesive according to the
invention (composition according to Table 1), SMP-920 and SMP-930 (Stauf Klebstoffwerk GmbH).

| | | L_{A} | L_{B} | Change |
|---|---|---|---|---|
| Adhesive | No. of measurement | [mm] | [mm] | L_{A} − L_{B} [%] |
| According to the invention according to Table 1 | 1 | 1018.2 | 1021.7 | 0.3437 |
| ″ | 2 | 1017.6 | 1020.4 | 0.2752 |
| ″ | 3 | 1020.3 | 1023.6 | 0.3234 |
| ″ | 4 | 1019.7 | 1022.5 | 0.2746 |
| ″ | 5 | 1016.1 | 1019.3 | 0.3149 |
| ″ | 6 | 1018.8 | 1021.1 | 0.2258 |
| ″ | 7 | 1016.6 | 1019.8 | 0.3148 |
| ″ | 8 | 1017.4 | 1019.7 | 0.2261 |
| | Average | 1018.1 | 1021.0 | 0.2873 |
| | Standard deviation | 1.46 | 1.51 | 0.0445 |
| SMP-930 | 1 | 1017.1 | 1024.7 | 0.7472 |
| ″ | 2 | 1019.8 | 1026.4 | 0.6472 |
| ″ | 3 | 1020.3 | 1025.9 | 0.5489 |
| ″ | 4 | 1016.3 | 1022.5 | 0.6101 |
| ″ | 5 | 1017.6 | 1026.7 | 0.8943 |
| ″ | 6 | 1018.5 | 1024.5 | 0.5891 |
| ″ | 7 | 1020.3 | 1025.3 | 0.4901 |
| | Average | 1018.6 | 1025.1 | 0.6467 |
| | Standard deviation | 1.62 | 1.43 | 0.1355 |
| SMP-920 | 1 | 1020.8 | 1027.9 | 0.6955 |
| ″ | 2 | 1020.1 | 1028.4 | 0.8136 |
| ″ | 3 | 1018.1 | 1025.9 | 0.7661 |
| ″ | 4 | 1017.9 | 1025.5 | 0.7466 |
| ″ | 5 | 1020.1 | 1026.7 | 0.6470 |
| ″ | 6 | 1017.4 | 1025.5 | 0.7961 |
| ″ | 7 | 1019.4 | 1025.3 | 0.5788 |
| | Average | 1019.1 | 1026.5 | 0.7206 |
| | Standard deviation | 1.31 | 1.25 | 0.0849 |

TABLE 5
Composition of the commercially available parquet adhesive SMP-
920 (Stauf Klebstoffwerk GmbH; proportions in percent by mass).

| | | | | Proportion |
|---|---|---|---|---|
| Raw material | Chemistry | Function | Manufacturer | [%] |
| S 203 H | Dimethoxymethylsilane-terminated | Binding agent, | Kaneka | 11 |
| | polypropylene oxide oligomer; MW: | basic polymer | | |
| | approx. 12,000 g/mol | | | |
| S 303 H | Dimethoxymethylsilane-terminated | Binding agent, | Kaneka | 6 |
| | polypropylene oxide oligomer; MW: | basic polymer | | |
| | approx. 18,000 g/mol | | | |
| Silquest A-171 | Vinyl trimethoxysilane | Drying agent | Momentive | 0.7 |
| Silquest A-1637 | 4-amino-3,3- | Adhesion promoter | Momentive | 0.7 |
| | dimethylbutyltrimethoxysilane | | | |
| TIB KAT 223 | Dioctyltin-bis(2,4-pentanedionate) | Catalyst | TIB Chemicals | 0.34 |
| Irganox 1726 | 4,6-bis(dodecylthiomethyl)-o-cresol | Antioxidant | Ciba | 0.1 |
| DINP | diisononylphthalate | Plasticizer | BASF | 20 |
| Crayvallac SLX | Polyamide wax | Rheological additive | Cray Valley | 0.4 |
| Omya BLP 3 | Limestone powder, surface- | Mineral component | Omya | 19.5 |
| | hydrophobised with stearic acid, average | | | |
| | particle diameter: 5.7 μm | | | |
| Calcilit 6 HS | Limestone powder, surface- | Mineral component | Alpha-Calcit | 8.66 |
| | hydrophobised with stearic acid, average | | | |
| | particle diameter: 7 μm | | | |
| MS 70 F | Limestone powder, average particle | Mineral component | Schön und | 15 |
| | diameter: 4.5 μm | | Hippelein | |
| Calcifin 20 H | Limestone powder, surface- | Mineral component | Alpha-Calcit | 16 |
| | hydrophobised with stearic acid, average | | | |
| | particle diameter 4.4 μm | | | |
| HDK H 18 | Highly dispersed silicic acid, surface- | Mineral component | Wacker | 1.6 |
| | silanised | | | |

TABLE 6
Composition of the commercially available parquet adhesive SMP-
930 (Stauf Klebstoffwerk GmbH; proportions in percent by mass).

| | | | | Proportion |
|---|---|---|---|---|
| Raw material | Chemistry | Function | Manufacturer | [%] |
| S 203 H | Dimethoxymethylsilane-terminated | Binding agent, | Kaneka | 3 |
| | polypropylene oxide oligomer; MW: | basic polymer | | |
| | approx. 12,000 g/mol | | | |
| S 303 H | Dimethoxymethylsilane-terminated | Binding agent, | Kaneka | 16 |
| | polypropylene oxide oligomer; MW: | basic polymer | | |
| | approx. 18,000 g/mol | | | |
| Dynasylan VTMO | Vinyl trimethoxysilane | Drying agent | Degussa | 0.8 |
| KBM 603 | N-2-(aminoethyl)-3- | Adhesion promoter | Shin-Etsu | 0.8 |
| | aminopropyltrimethoxysilane | | | |
| Neostann | Dibutyltin diacetylacetonate | Catalyst | Nitto Kasei | 0.32 |
| U 220 H | | | | |
| Irganox 1726 | 4,6-bis(dodecylthiomethyl)-o-cresol | Antioxidant | Ciba | 0.1 |
| Palatinol 10-P | bis(2-propylheptylphthalate) | Plasticizer | BASF | 11 |
| Mesamoll | Phenolalkylsulphonic acid ester | Plasticizer | Bayer | 4 |
| Thixatrol MAX | Polyamide wax | Rheological additive | elementis | 0.5 |
| Omyacarb 10 BG | Limestone powder, average particle | Mineral component | Omya | 19.5 |
| | diameter: 7 μm | | | |
| Calcifin 20 H | Limestone powder, surface- | Mineral component | Alpha-Calcit | 41.58 |
| | hydrophobised with stearic acid, average | | | |
| | particle diameter: 4.4 μm | | | |
| Socal 312 | Precipitated calcium carbonate, coated, | Mineral component | Solvay | 2.4 |
| | average particle diameter: 0.07 μm | | | |

The following embodiments further illustrate the invention but, of course, should not be construed as in any way limiting its scope.
Embodiment 1. Water-, solvent- and phthalate-free, one-component parquet adhesive which is based on silane-terminated polyalkylene oxide oligomers,
   wherein it comprises the following materials or consists of them:
   a) 10 to 30 percent by mass of a moisture-reactive, silane-terminated polyalkylene oxide binding agent with an average molecular weight of 6,000 to 20,000 g/mol, the silane functions being bonded via urethane- and/or urea groups to the oligomeric skeletal structure,
   b) 30 to 60 percent by mass of a surface-hydrophobised chalk powder with an average particle diameter of 0.8 to 4.0 μm,
   c) 2 to 10 percent by mass of a surface-hydrophobised chalk powder with an average particle diameter of 0.2 to 0.7 μm,
   d) 3 to 15 percent by mass of a surface-hydrophobised wollastonite with an average needle length of 15 to 60 μm and an average aspect ratio of 3:1 to 12:1,
   e) 0.2 to 3 percent by mass of a moisture-reactive, silane-modified drying agent, and also
   f) 0.3 to 4 percent by mass of a moisture-reactive, silane-modified adhesion promoter,
   the percentage data relating to the mass of the ready-to-use parquet adhesive and the sum of the components a) to f) being 45.5% to 100%.
Embodiment 2. Water-, solvent- and phthalate-free, one-component parquet adhesive according to embodiment 1,
   wherein it comprises the following materials or consists of them:
   a) 16 to 26 percent by mass of a moisture-reactive, silane-terminated polyalkylene oxide binding agent with an average molecular weight of 7,000 to 13,000 g/mol, the terminal silane functions being bonded via urethane- and/or urea groups to the oligomeric skeletal structure,
   b) 44 to 54 percent by mass of a surface-hydrophobised chalk powder with an average particle diameter of 0.8 to 1.8 μm,
   c) 3 to 6 percent by mass of a surface-hydrophobised chalk powder with an average particle diameter of 0.3 to 0.6 μm,
   d) 5 to 10 percent by mass of a surface-hydrophobised wollastonite with an average needle length of 25 to 45 μm and an average aspect ratio of 5:1 to 10:1,
   e) 0.5 to 1.5 percent by mass of a moisture-reactive, silane-modified drying agent, and also
   f) 1 to 3 percent by mass of a moisture-reactive, silane-modified adhesion promoter,
   the percentage data relating to the mass of the ready-to-use parquet adhesive and the sum of the components a) to f) being 69.5% to 100%.
Embodiment 3. Water-, solvent- and phthalate-free, one-component parquet adhesive according to one of the preceding embodiments, wherein the mass ratio of component b) to component c) is 9:1 to 15:1 and the mass ratio of component c) to component d) is 1:1.5 to 1:2.
Embodiment 4. Water-, solvent- and phthalate-free, one-component parquet adhesive according to one of the preceding embodiments, wherein the terminal silane groups of the silane-terminated polyalkylene oxide binding agent according to a) are trimethoxysilane groups, the polymeric skeletal structure is polypropylene oxide and the average molecular weight is 10,000 g/mol.
Embodiment 5. Water-, solvent- and phthalate-free, one-component parquet adhesive according to one of the preceding embodiments, wherein the chalk powder according to b) has an average particle diameter of 1.0 μm and the chalk powder according to c) has an average particle diameter of 0.4 μm.
Embodiment 6. Water-, solvent- and phthalate-free, one-component parquet adhesive according to one of the preceding embodiments, wherein the wollastonite according to d) has an average needle length of 39 μm and an average aspect ratio of 7:1.
Embodiment 7. Water-, solvent- and phthalate-free, one-component parquet adhesive according to one of the preceding embodiments, wherein the viscosity of the ready-to-use adhesive, measured according to DIN EN ISO 2555:2000-01 (20 rpm), is 109,700±6,800 mPa·s.
Embodiment 8. Water-, solvent- and phthalate-free, one-component parquet adhesive according to one of the preceding embodiments, wherein the tension shear strength, measured according to DIN EN 14293:2006-10 (storage type A), is 4.31±0.27 N/mm² and the modulus of elasticity, measured according to DIN EN ISO 527-1:1996-04 and DIN EN ISO 527-3:2003-07), is 8.54±0.46 N/mm².
Embodiment 9. Use of the water-, solvent- and phthalate-free, one-component parquet adhesive which is based on silane-terminated polyalkylene oxide oligomers according to one of the preceding embodiments for gluing parquet, wooden floor coverings and/or wood-based material boards to a sub-floor.
Embodiment 10. Use of the water-, solvent- and phthalate-free, one-component parquet adhesive according to the preceding embodiment, wherein the sub-floor is dry or moist and consists of concrete, cement, cement screed, cement liquid screed, cement mortar, cement-bonded wood fibre, ceramic, natural stone, calcium sulphate screed, calcium sulphate liquid screed, magnesite screed, wood, wood-based material, plywood, cork, gypsum, gypsum fibre, gypsum plasterboard, hardboard, mineral knifing filler, textile fibrous material or a combination of these sub-floors and the glued parquet, the wooden floor coverings and/or the wood-based material boards consist totally or partially of European deciduous- and/or coniferous types of timber, non-European types of timber or a combination of these types of timber.

It shall be noted that the preceding are merely examples of embodiments. Other exemplary embodiments are apparent from the entirety of the description herein. It will also be understood by one of ordinary skill in the art that each of these embodiments may be used in various combinations with the other embodiments provided herein.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. Water-, solvent- and phthalate-free, one-component parquet adhesive which is based on silane-terminated polyalkylene oxide oligomers,
wherein it comprises the following materials or consists of them:
a) 10 to 30 percent by mass of a moisture-reactive, silane-terminated polyalkylene oxide binding agent with an average molecular weight of 6,000 to 20,000 g/mol, the silane functions being bonded via urethane- and/or urea groups to the oligomeric skeletal structure,
b) 30 to 60 percent by mass of a surface-hydrophobised chalk powder with an average particle diameter of 0.8 to 4.0 μm,
c) 2 to 10 percent by mass of a surface-hydrophobised chalk powder with an average particle diameter of 0.2 to 0.7 μm,
d) 3 to 15 percent by mass of a surface-hydrophobised wollastonite with an average needle length of 15 to 60 μm and an average aspect ratio of 3:1 to 12:1,
e) 0.2 to 3 percent by mass of a moisture-reactive, silane-modified drying agent, and also
f) 0.3 to 4 percent by mass of a moisture-reactive, silane-modified adhesion promoter,
the percentage data relating to the mass of the ready-to-use parquet adhesive and the sum of the components a) to f) being 45.5% to 100%.

2. Water-, solvent- and phthalate-free, one-component parquet adhesive according to claim 1,
wherein it comprises the following materials or consists of them:
a) 16 to 26 percent by mass of a moisture-reactive, silane-terminated polyalkylene oxide binding agent with an average molecular weight of 7,000 to 13,000 g/mol, the terminal silane functions being bonded via urethane- and/or urea groups to the oligomeric skeletal structure,
b) 44 to 54 percent by mass of a surface-hydrophobised chalk powder with an average particle diameter of 0.8 to 1.8 μm,
c) 3 to 6 percent by mass of a surface-hydrophobised chalk powder with an average particle diameter of 0.3 to 0.6 μm,
d) 5 to 10 percent by mass of a surface-hydrophobised wollastonite with an average needle length of 25 to 45 μm and an average aspect ratio of 5:1 to 10:1,
e) 0.5 to 1.5 percent by mass of a moisture-reactive, silane-modified drying agent, and also
f) 1 to 3 percent by mass of a moisture-reactive, silane-modified adhesion promoter,
the percentage data relating to the mass of the ready-to-use parquet adhesive and the sum of the components a) to f) being 69.5% to 100%.

3. Water-, solvent- and phthalate-free, one-component parquet adhesive according to claim 1, wherein the mass ratio of component b) to component c) is 9:1 to 15:1 and the mass ratio of component c) to component d) is 1:1.5 to 1:2.

4. Water-, solvent- and phthalate-free, one-component parquet adhesive according to claim 1, wherein the terminal silane groups of the silane-terminated polyalkylene oxide binding agent according to a) are trimethoxysilane groups, the polymeric skeletal structure is polypropylene oxide and the average molecular weight is 10,000 g/mol.

5. Water-, solvent- and phthalate-free, one-component parquet adhesive according to claim 1, wherein the chalk powder according to b) has an average particle diameter of 1.0 μm and the chalk powder according to c) has an average particle diameter of 0.4 μm.

6. Water-, solvent- and phthalate-free, one-component parquet adhesive according to claim 1, wherein the wollastonite according to d) has an average needle length of 39 μm and an average aspect ratio of 7:1.

7. Water-, solvent- and phthalate-free, one-component parquet adhesive according to claim 1, wherein the viscosity of the ready-to-use adhesive, measured according to DIN EN ISO 2555:2000-01 (20 rpm), is 109,700±6,800 mPa·s.

8. Water-, solvent- and phthalate-free, one-component parquet adhesive according to claim 1, wherein the tension shear strength, measured according to DIN EN 14293:2006-10 (storage type A), is 4.31±0.27 N/mm² and the modulus of elasticity, measured according to DIN EN ISO 527-1:1996-04 and DIN EN ISO 527-3:2003-07), is 8.54±0.46 N/mm².

9. Use of the water-, solvent- and phthalate-free, one-component parquet adhesive which is based on silane-terminated polyalkylene oxide oligomers according to claim 1 for gluing parquet, wooden floor coverings and/or wood-based material boards to a sub-floor.

10. Use of the water-, solvent- and phthalate-free, one-component parquet adhesive according to the claim 9, wherein the sub-floor is dry or moist and consists of concrete, cement, cement screed, cement liquid screed, cement mortar, cement-bonded wood fibre, ceramic, natural stone, calcium sulphate screed, calcium sulphate liquid screed, magnesite screed, wood, wood-based material, plywood, cork, gypsum, gypsum fibre, gypsum plasterboard, hardboard, mineral knifing filler, textile fibrous material or a combination of these sub-floors and the glued parquet, the wooden floor coverings and/or the wood-based material boards consist totally or partially of European deciduous- and/or coniferous types of timber, non-European types of timber or a combination of these types of timber.
